(19) United States
(12) Patent Application Publication
(10) Pub. No.: US 2012/0037585 A1
(43) Pub. Date: Feb. 16, 2012

(54) MONITORING AND ALARM DEVICE FOR CONSTRUCTION MACHINERY

(75) Inventor: Thilo Jene, Spiesen (DE)

(73) Assignee: TEREX DEMAG GMBH, Zweibrucken (DE)

(21) Appl. No.: 13/205,130

(22) Filed: Aug. 8, 2011

(30) Foreign Application Priority Data
Aug. 11, 2010 (DE) 202010011345.8

(51) Int. Cl. B66C 15/06

(52) U.S. Cl. 212/276

(57) ABSTRACT

The invention relates to a monitoring and alarm device for construction machinery having long and heavy booms, such as cranes, in particular mobile cranes, is characterized in that a monitor system is provided, which monitors parameters that may change in case of an undesired lowering of the boom or of boom sections in a non-operating condition, and triggers an optical and/acoustic and/or wireless alarm system if the parameters change.

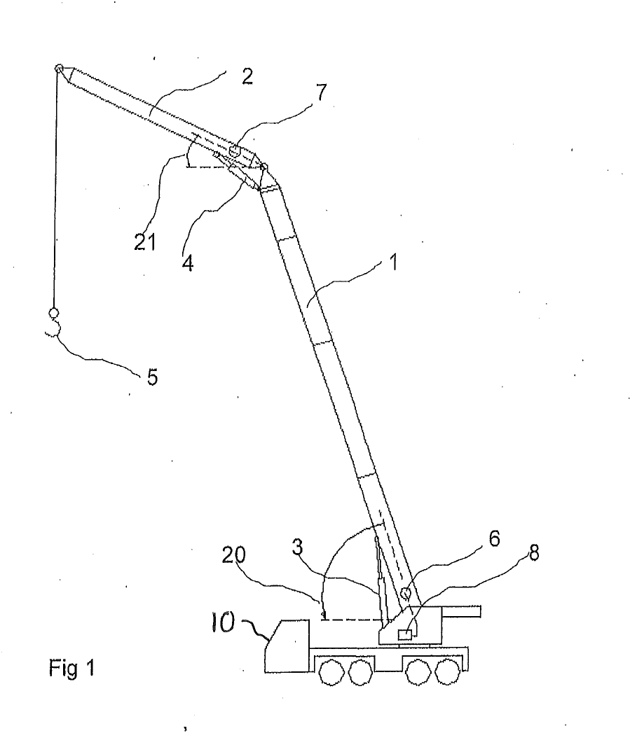

### CROSS REFERENCE TO RELATED APPLICATION

This application claims the benefit of German patent application No. 20 2010 011 345.8 Filed Aug. 11, 2010, the contents of which are incorporated in there entirety herein by reference thereto.

### FIELD OF THE INVENTION

The invention relates to a monitoring and alarm device for construction machinery having long and heavy booms such as cranes and, in particular, mobile cranes.

### BACKGROUND

Very slow dropping of the boom due to leakages can never be ruled out with absolute certainty when load-holding valves or check valves are used. This is hardly noticeable owing to the large oil volume in the luffing cylinders. If, due to the surrounding area and task, e.g. in narrow street canyons or refineries, the crane cannot be removed during prolonged downtimes, a minor leakage as a result of contamination, for example, causes the boom or part of the boom to drop. This may result in collisions with the surrounding area or tilting of the crane.

It has been known to provide one or more load-holding valves, which check the pressure in the luffing cylinder(s). Smaller construction vehicles, e.g. excavators, are usually provided with mechanical safety devices in order to prevent the boom from lowering due to leakages. U-shaped sleeves placed around the cylinder rods can be seen, for example, at construction vehicle fairs. Such sleeves would be too heavy and too difficult to handle for mobile cranes.

The object of the invention is to prevent accidents caused by very slow unnoticeable changes in the setup condition as a result, for example, of unnoticed lowering of booms or boom extensions, or unnoticed telescopically retracting booms or boom extensions, or unnoticeably retracting outrigger cylinders when the crane operator is not in the cabin and the crane is not in operational use.

### SUMMARY

A monitoring and alarm device for construction machinery having long and heavy booms, such as cranes, in particular mobile cranes, characterized in that a monitor system is provided, which monitors parameters that may change in case of an undesired lowering of the boom or of boom sections in a non-operating condition, and triggers an optical and/acoustic and/or wireless alarm system if the parameters change.

The above features and advantages, and other features and advantages of the present invention are readily apparent from the following detailed description when taken in connection with the accompanying drawing.

### BRIEF DESCRIPTION OF THE DRAWING

Other objects, features, advantages and details appear, by way of example only, in the following detailed description of the embodiments, the detailed description referring to the following drawing in which an exemplary embodiment of a mobile crane is illustrated embodying the invention.

### DESCRIPTION OF THE EMBODIMENTS

The following description is merely exemplary in nature and is not intended to limit the present disclosure, its application or uses.

A monitoring and alarm device 8 for construction machinery having long and heavy booms, such as cranes, in particular mobile cranes 10, is characterized in that a monitor system is provided, which monitors parameters that may change in case of an undesired lowering of the boom or of boom sections 1 and 2 in a non-operating condition, and triggers an optical and/acoustic and/or wireless alarm system if the parameters change.

A monitoring of the parameters that change when the boom or boom sections 1 and 2 lower, is to take place according to the invention, since it has not been possible thus far to reliably prevent the boom from lowering due to leakages. These parameters are in particular the boom angles 20 and 21 and/or the hydraulic pressure in the luffing cylinder or cylinders 3 and 4, as well as the length of the boom sections 1 and 2.

It is also conceivable to monitor the cylinder lengths or geometries or positions.

If a tolerance field of the parameters is exceeded or falls short, a warning message is emitted by the crane control or by a separate monitoring system (not shown). This warning message can be directly emitted optically or acoustically by the crane 10 and can warn the immediately surrounding areas of the construction site and can also be communicated wirelessly or via SMS to a central location in order to allow an absent crane operator to return the crane 10 to the safe area.

The monitoring device or system 8 must function in particular if the crane 10 is not operating for a longer period of time, for example, during the night or over the weekend. For the purpose of not discharging the crane battery is made available

A supply of the monitoring control system by means of an autonomous unit,

A supply of the monitoring control system by means of separate batteries,

A supply of the monitoring control system by means of a power supply line

because the crane control, or at least parts thereof, must be active for monitoring.

Warning messages can be sent to qualified operating staff, for example, via wireless messages, SMS, optical signals, or acoustic signals.

The monitoring device is preferably used for load-bearing cylinders, such as those used, for example, in mobile cranes 10 for

Luffing cylinders 3 of the main boom 1

Luffing cylinders 4 of adjustable boom extensions 2

Outrigger cylinders

Telescopic cylinders of main booms

Telescopic cylinders of telescopic boom extensions

Anchoring cylinders of boom anchors

In the non-operating condition, the monitoring device is preferably coupled to an already existing overload limiter and/or to a working range limiter, and the sensors, which are already available for load torque limitation and/or working range limitation, are used for monitoring purposes.

The already available input accesses of the crane control system can likewise be used for the input of tolerance limits and of parameters to be monitored.

Integration into a teleservice system, which informs a central location about the condition of the crane, such as, for example, operating hours, oil status, or utilization ratio,

Such teleservice systems are prior art, as are also the signal transmission options which can then also be used for monitoring. The warning message to the construction site or to the crane operator is then issued by the central location.

The tolerance limits until the warning message is triggered can be defined by the crane operator in adaptation to the respective situation.

The tolerance limits until the emission of a warning message can conveniently be predefined in that the crane operator approaches a tolerance limit by actuating the crane and confirms this in the monitoring control system. The procedure is comparable to the limitation of a working range.

The tolerance limits until a warning message is emitted can be entered as numerical values of the parameters to be monitored, the tolerance limits can be fixed, but are dependent upon the respective setup condition.

The tolerance limits until a warning message is emitted can be generated by an operations planning tool, in particular a computer-assisted operations planner.

Such crane operation planners are prior art and are used for the preliminary simulation of a crane operation.

The warning message can distinguish different degrees of urgency, so that only the crane driver is alerted in a first instance, and area surrounding the crane in a second instance.

The system already available in the crane 10 for limiting the load torque can be used as a measuring system, or an additional system can be used exclusively or in part for the monitoring.

Monitoring can be carried out by means of a GPS system (not shown) which detects the position of the crane components and/or the changes thereof. GPS units, via which changes in position can be detected, are attached for this purpose to the mobile crane parts.

Monitoring can be carried out by means of optical sensors (not shown) or camera systems (not shown).

Parts of the crane control can be shut off and reduced to the minimum required for monitoring the setup state in the monitoring mode. The crane battery is less strained as a result of this.

The monitoring system 8 can also comprise a hydraulic backfeed, which prevents the drainage of the cylinders 3 and 4 in case of sagging. If load-holding winches are monitored, the motor is prevented from cavitating by the backfeed and/or by the installation of a hydraulic bridge between both pressure connections of the winch motor in case of lowering.

The monitoring device can be permanently activated or be manually activated and/or deactivated by the crane driver, or can also be automatically activated when the crane is shut off.

The monitoring parameters can be transmitted to other construction machinery, in particular cranes, and can have an influence on known anti-collision controls therein. They usually only comprise of fixed geometries of non-operating cranes, but not unintentional movements. An unintentional movement of a non-operating crane as a consequence of a lowering of boom sections could thus result in the failure of the anti-collision controls of other cranes.

The monitoring system 8 can also monitor the setup condition of the crane 10 while the crane is in operation, but no if a crane movement is actuated by the crane operator. Possible unintentional crane movements due to leakages are thus detected before the crane is shut down.

The parameters can be monitored continuously as well as at discrete times by retrieving the parameters after predefined time intervals and comparing them to the parameters stored at the beginning of the monitoring process. The monitoring means can be on standby energy-saving mode between the discrete times.

The advantages of the invention are an increased safety of non-operating mobile cranes and/or of the surrounding area of the rigged cranes. A permanent presence of the crane operator at the control console is additionally not necessary during prolonged downtimes of the crane 10.

During operation, crane operator activates the monitoring system before leaving the crane 10 if the crane is shut down in rigged condition and is expected to remain in this position without the presence of a crane operator at the control console of the crane for a prolonged period of time.

The monitoring system subsequently store the angles 20 of the crane boom 1 as well as the angles 21 of the auxiliary boom 2 measured by the angle sensors 6 and/or the electronics of the monitoring system 8.

The crane operator can input tolerance limits for different parameters until the emission of a warning message. After leaving the crane, the monitoring device 8 remains active; all control functions that are not required for this purpose as well as the drive units are shut off.

If the tolerance limits for one or more parameters are now exceeded, because the crane components 1 and/or 2 are lowering due to changes in the angles 21 and/or 22 caused by leakages from the cylinders 3 and/or 4, partial systems of the crane control are booted and warning messages are issued. This can take place, for example, in the form of an SMS, which is transmitted to the crane operator. The crane operator can stay, for example, in a sleeping container, which is common at large construction sites, and reach the crane 10 with enough time to prevent the dangerous situation by starting and controlling the crane. The construction site can furthermore be alerted by means of acoustic and/or optical warning signals, which can either originate directly at the crane or at a central location, which is then in turn activated by means of a signal originating at the crane, e.g. wirelessly.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

1. A monitoring and alarm device for construction machinery having long and heavy booms or boom sections, such as cranes, in particular mobile cranes, characterized in that the monitoring device monitors parameters that can change during an undesired lowering of the boom or boom sections when the crane is not in operation, and alarm signals, which trigger an optical and/or acoustic and/or wireless alarm system when the parameters change, can be emitted.

2. The monitoring and alarm device according to claim 1, characterized in that the monitoring device is arranged on load-bearing cylinders, such as the luffing cylinder of the main boom, on the luffing cylinder of adjustable boom extensions, on outrigger cylinders, on telescopic cylinders of main booms, on telescopic cylinders of telescopic boom extensions, or on anchoring cylinders of boom anchors.

3. A monitoring and alarm device according to claim 1, characterized in that the monitoring and alarm device can distinguish between different degrees of urgency, so that only a crane driver is alerted in a first degree of urgency, and a crane surrounding area in a second degree of urgency.

4. A monitoring and alarm device according to claim 1, characterized in that the monitoring and alarm comprise a GPS system, which detects the position of the crane and crane components or the changes thereof.

5. A monitoring and alarm device according to claim 2, characterized in that the monitoring and alarm device additionally comprise a hydraulic backfeed, which prevents the drainage of the cylinders in case of a pressure loss.

6. A monitoring and alarm device according to claim 1, characterized in that A monitoring and alarm device is permanently activated or manually activated and/or deactivated by the crane driver or is automatically activated when the crane is shut off.

7. A monitoring and alarm device according to claim 1, characterized in that the monitoring and alarm device is connected to an autonomous unit that generates electricity or to batteries or to a power supply line in order to relieve the strain on the crane battery.

8. A monitoring and alarm device according to claim 1, characterized in that the monitoring and alarm device is connected to an already existing overload limiter and/or working range limiter of the crane and also comprise the sensors available for the load torque limitation and/or working range limitation, and the input accesses of the crane control system can be used for the input of tolerance limits for the parameters to be monitored.

9. A monitoring and alarm device according to claim 1, characterized in that the warnings of the monitoring and alarm device can be transmitted to other construction machinery, in particular cranes, and have an influence on the anti-collision controls available therein.

10. A monitoring and alarm device according to claim 1, characterized in that the monitoring and alarm device is connected to a teleservice system, which informs a central location about the crane condition, such as, for example, the operating hours, oil status, or utilization ratio.

11. A method for monitoring construction machinery having long and heavy booms or boom sections, such as cranes, in particular mobile cranes, having a monitoring and alarm device comprises monitoring parameters that can change during an undesired lowering of the boom or boom sections when the crane is not in operation and issuing alarm signals, which triggers an optical and/or acoustic and/or wireless alarm system when the parameters change.

12. The method for monitoring construction machinery of claim 11 further comprising monitoring the change in angles between crane booms.

13. The method for monitoring construction machinery of claim 11 further comprising monitoring the change in length of the crane cylinders.
